(19) United States
(12) Patent Application Publication
(10) Pub. No.: US 2016/0104176 A1
(43) Pub. Date: Apr. 14, 2016

(54) VISUALIZING FORECAST DATA

(71) Applicant: salesforce.com, inc., San Francisco, CA (US)

(72) Inventor: Alon Kama, Pleasanton, CA (US)

(21) Appl. No.: 14/689,013

(22) Filed: Apr. 16, 2015

Related U.S. Application Data
(60) Provisional application No. 62/062,870, filed on Oct. 11, 2014.

(51) Int. Cl. G06Q 30/02; G06F 3/0484; G06F 3/0481

(52) U.S. Cl. CPC G06Q 30/0202; G06F 3/0481; G06F 3/04842

(57) ABSTRACT

Methods, systems, apparatus, and machine-readable media facilitate visualizing forecast data in a user device. In a device associated with a user, a method is implemented to collect, summarize and display data reported for a user in a summary format according to certain preferences. The method overlays the data in the summary format with a graphical overlay associated with a forecast of the data. Overlaying the data facilitates viewing and interpreting the reported data at a glance, the overlay providing a comparison between the reported data and a forecast represented by the graphical overlay. The method may further include interacting with the displayed data and graphical overlay to adjust/override the forecast. Corresponding methods, systems, apparatus, and machine-readable media for visualizing forecast data can be implemented in servers supporting the user device.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application claims the benefit of U.S. Provisional Application No. 62/062,870, filed on Oct. 11, 2014, the entire contents of which are hereby incorporated by reference herein.

### TECHNICAL FIELD

Embodiments of the invention relate generally to the field of computing, and more particularly, to software applications developed for reporting and display data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

One of the challenges in developing software applications for business enterprises is presenting the large amounts of data that enterprises generate in a way that is meaningful to users. At the same time, enterprises have increasingly turned to enterprise cloud computing services to minimize the cost of developing software applications.

Among other advantages, enterprise cloud computing services provide data analytics and report generators to help businesses get the most out of their data. Even so, it can be difficult to harness and present data in a meaningful way when that data changes often, comes from several different sources and/or cannot be processed with the standard analytic and report generation tools provided by the enterprise cloud computing service.

Moreover, individuals now use mobile devices to view data reports in the field or on the go. The standard tools may generate static reports that are too detailed or voluminous to be easily viewed on a mobile device, or that fail to exploit the user interaction capabilities of the mobile and desktop devices on which reports are viewed.

### BRIEF DESCRIPTION OF THE DRAWINGS

The present invention is illustrated by way of example and not limitation in the figures of the accompanying drawings, in which like references indicate similar elements and in which:

FIG. 1 illustrates an overview of a system for visualizing forecast data in an enterprise cloud platform operating environment according to one embodiment;

FIG. 2 is a flow diagram illustrating a process for visualizing forecast data according to one embodiment;

FIG. 3 illustrates an exemplary graphical user interface (GUI) for visualizing forecast data on a device according to one embodiment;

FIG. 4 illustrates another exemplary GUI for visualizing forecast data on a device according to one embodiment;

FIG. 5 illustrates yet another exemplary GUI for visualizing forecast data on a device according to one embodiment;

FIG. 6 illustrates yet another exemplary GUI for visualizing forecast data on a device according to one embodiment; and

FIGS. 7A-7B illustrate exemplary elements of an operating environment of a system for visualizing forecast data according to one embodiment.

### DETAILED DESCRIPTION

In keeping with the foregoing observations, embodiments of a system for visualizing forecast data is described in which data is collected, summarized and displayed on a display device with graphics to facilitate visualization of the data and forecasts related to the data. In one embodiment the visualization of data and forecasts related to the data facilitates user interaction with the forecast, including user interaction with the display device to adjust or override the forecast.

Embodiments of methods and systems are described for facilitating visualizing forecast data on computing devices in an enterprise cloud computing environment, including in an on-demand services and multi-tenant environment. Embodiments may be implemented on a platform that enables mobile applications to be built and deployed on mobile devices, such as tablet computers, smartphones, wearable devices, touch-enabled devices, etc., operating on any number and type of operating systems.

In one embodiment, using an application running on a platform provided by an enterprise cloud platform operating environment, such as HEROKU®, or Salesforce1®, methods and systems for facilitating visualizing forecast data on computing devices may employ events or features associated with images, such as HyperText Markup Language (“HTML”), etc., and components, such as Visualforce® components, SOQL and APEX components etc., that may rely on data residing in the enterprise cloud or in an on-demand services environment. It is contemplated that embodiments are not limited to any particular number or type of operating systems, such as Apple® iOS®, Android®, etc. Similarly, it is contemplated that any number and type of libraries (e.g., jQuery, AngularJS, KineticJS, NodeJS, ExpressJS, HammerJS, iScroll, etc.) may be used to generate an application for facilitating visualizing forecast data on computing devices in the enterprise cloud or on-demand services environment.

It is contemplated that embodiments and their implementations are not merely limited to use in a multi-tenant database system (“MTDBS”) and can be used in other environments, such as a client-server system, a mobile device, a personal computer (PC), a web services environment, etc. However, for the sake of brevity and clarity, throughout this document, embodiments are described as being used in a multi-tenant database system, such as Salesforce.com®, which is to be regarded as an example of an on-demand services environment.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers.

Embodiments are described in which techniques for facilitating visualization of forecast data in an on-demand services environment are implemented in a system having an application server providing a front end for an on-demand database service capable of supporting multiple tenants. However it should be understood that the described embodiments are not limited to multi-tenant databases nor deployment on application servers. Embodiments may be practiced using other database architectures, i.e., ORACLE®, DB2® by IBM and the like without departing from the scope of the embodiments claimed.

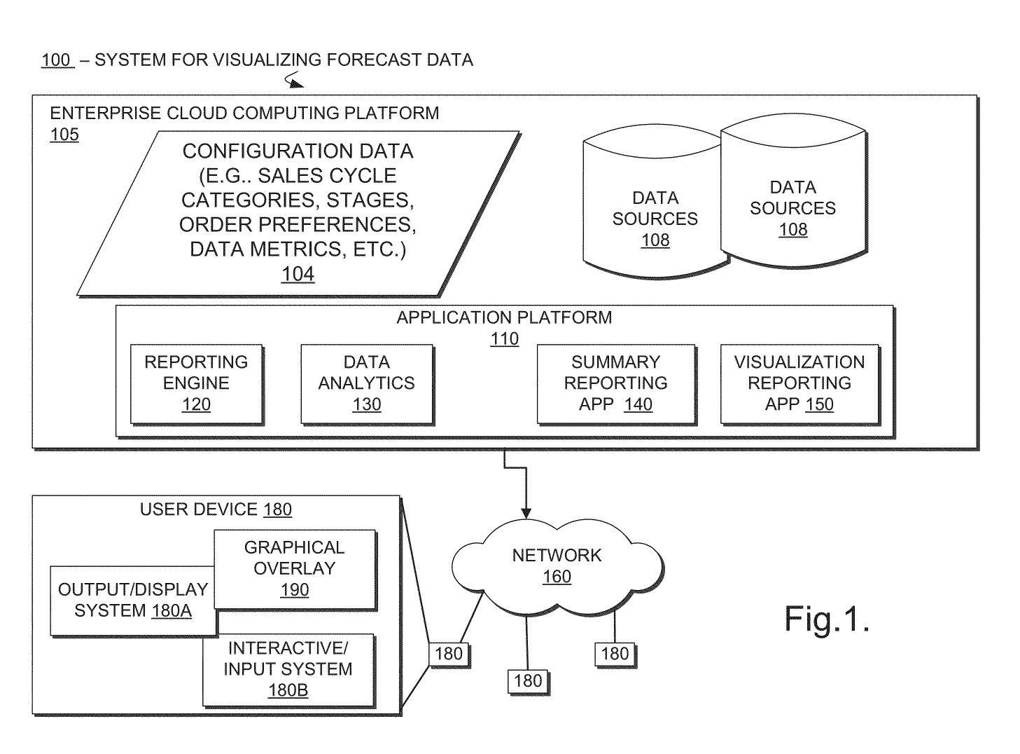

FIG. 1 illustrates an overview of an exemplary system 100 for visualizing forecast data operating in an enterprise cloud computing platform 105 in accordance with one embodiment. The system 100 includes, among others, components for summary 140 and visualization 150 reporting that operate in conjunction with the reporting engine 120 and data analytics 130 provided on an application platform 110 of the enterprise cloud computing platform 105.

In one embodiment, the components for summary and visualization reporting 140/150 collect and summarize data reported for a user from one or more data sources 108 in accordance with a particular configuration 104, the particular configuration 104 including various pre-defined options for describing and interpreting data. For example, in a configuration for using the system 100 to report on data in a sales system, the configuration might include various sales cycle options, such as the sales opportunity and sales lead categories, stages, order preferences, and data metrics, such as quotas and forecasts. The system 100 transmits the collected and summarized data over network 160 to user device 180. The user device 180 displays the transmitted data in a summary format using the device's output/display system 180A.

In one embodiment the components for summary and visualization reporting 140/150 generate, in conjunction with the output/display system 180A, a graphical overlay 190 that the user device 180 overlays on the data displayed in the summary format using the output/display system 180A. The graphical overlay 190 is a visual aid that is associated with a data metric related to the data displayed in the summary format on the user's device 180. For example, in the context of a sales management scenario, in one embodiment the graphical overlay 190 is a quota attainment graphic that, when overlaid on sales opportunity revenue and sales opportunity quantity data displayed in the summary format, reveals whether and/or how much a user's forecasted sales opportunity quota has been met or exceeded.

The term “user” may refer to a system user, such as, but not limited to, a software/application developer, a system administrator, a database administrator, an information technology professional, a program manager, product manager, etc. The term “user” may also refer to an end-user, such as, but not limited to, an organization (e.g., a business, a company, a corporation, a non-profit entity, an institution, an agency, etc.) serving as a customer or client of the provider (e.g., Salesforce.com®) of mobile mechanism 110 or an organization's representative, such as a salesperson, a sales manager, a product manager, an accountant, a director, an owner, a president, a system administrator, a computer programmer, an information technology (“IT”) representative, etc.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com, Salesforce1®, Apex™ code, JavaScript™, jQuery™, Developerforce™, Visualforce™, Service Cloud Console Integration Toolkit™ (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

Platforms 105/110 may include server computers (e.g., cloud server computers, etc.), desktop computers, cluster-based computers, set-top boxes (e.g., Internet-based cable television set-top boxes, etc.), and the like. Platforms 105/110 and user devices 180 may include smaller computers, such as mobile computing devices, such as cellular phones including smartphones (e.g., iPhone® by Apple®, BlackBerry® by Research in Motion® Limited, now known and trading as BlackBerry®, etc.), handheld computing devices, personal digital assistants (“PDAs”), etc., tablet computers (e.g., iPad® by Apple®, Galaxy® by Samsung®, etc.), laptop computers (e.g., notebooks, netbooks, Ultrabook™ systems, etc.), e-readers (e.g., Kindle® by Amazon.com®, Nook® by Barnes and Nobles®, etc.), media internet devices (“MIDs”), smart televisions, television platforms, wearable devices (e.g., glasses (e.g., Google® Glass® by Google®, watches, bracelets, smartcards, jewelry, clothing items, etc.), media players, Global Positioning System (“GPS”)-based navigation systems, cable setup boxes, etc.

The platforms 105/110 and user devices 180 include an operating system (“OS”) serving as an interface between any hardware or physical resources of the platforms/devices 105/110/180 and a user. The platforms/devices 105/110/180 further include one or more processors, memory devices, network devices, drivers, or the like, as well as input/output (“I/O”) sources, such as output/display system 180A and interactive input system 180B, including touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request” and “message” may be used interchangeably throughout this document. It is to be further noted that terms like “build”, “generate”, “create”, “develop”, “make”, or the like, and any of their variations, such as “building”, “generating”, “creating”, developing”, “making”, respectively, may be referenced interchangeably throughout this document.

In a typical environment, the summary and visualization reporting components 140/150 are implemented together with an application installed on a mobile user device 180 having an interactive touch screen display 180A/180B and a mobile operating system, such as an iOS or Android operating system. The application and components 140/150 operate together to provide the user of the device 180 with an easy-to-use touch interactive GUI to track and, at a glance, quickly interpret the data displayed in the summary format.

In one embodiment, the graphical overlay 190 includes a feature that allows the user to interact with the graphical overlay and/or the data displayed in the summary format. For example, in the sales management scenario described above, a salesperson can use their device 180 to interact with the graphical overlay 190 to adjust or override the data metric 104 associated with the graphical overlay, i.e. to adjust and/or override their quota forecast for their sales opportunity revenue, sales opportunity quantity and sales leads.

In some embodiments, the summary and visualization reporting components 140/150 can also operate in conjunction with a mobile or stationary user device 180 having a web-browser platform that enables the user of the user device 180 to interact with servers running on platforms 105/110 for secure online access to their data displayed in the summary format in a manner similar to an application running on the user device 180.

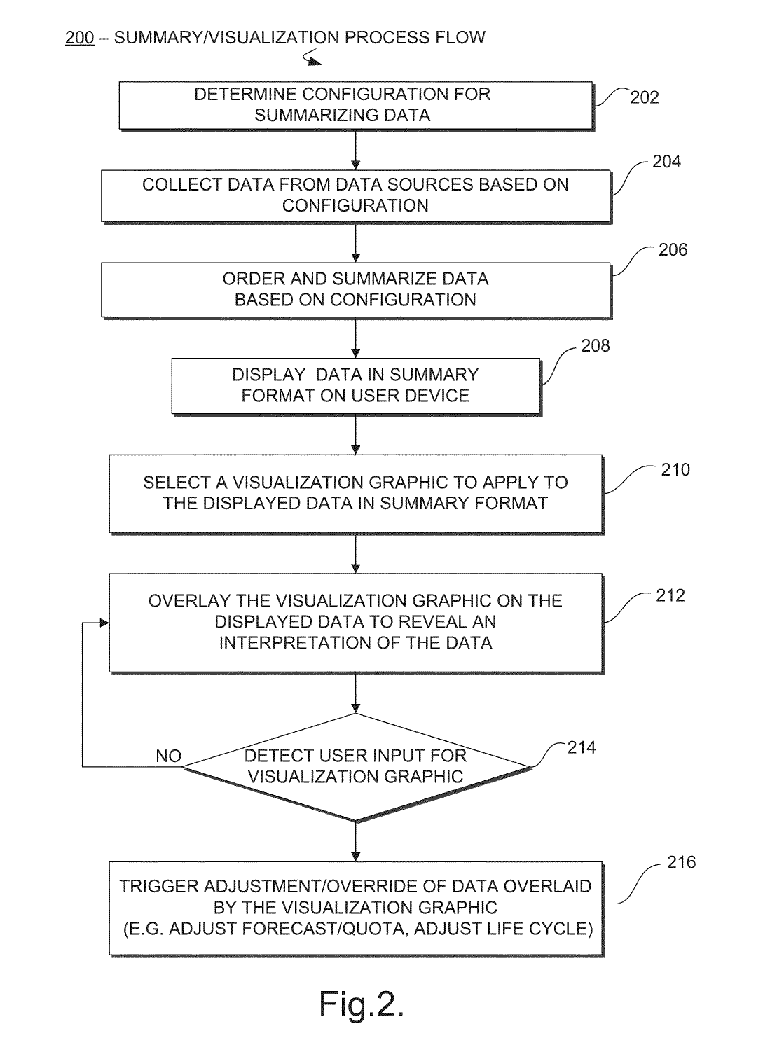

FIG. 2 is a high-level flow diagram illustrating a summary/visualization process 200 for carrying out a system for visualizing forecast data according to an embodiment. With reference to FIG. 2, the components 140/150, operating in conjunction with other components of the platforms 105/110 and the user device 180, determine 202 a configuration 104 for the data to be summarized and visualized.

For example, in one embodiment in the sales management system scenario, the configuration may contain sales cycle preferences, including the categories and stages within which to summarize the data, such as sale opportunity revenue, quantity and leads. The preferences may further include the time periods within which to summarize the data, such as quarterly, monthly, etc. In one embodiment, the configuration 104 further includes ordering preferences and data metrics, such as forecast quotas of sales revenue, quantity and leads that will be used to track and interpret the data.

The process 200 continues at 204 to collect data from data sources in accordance with the determined configuration 104. At 206, the process 200 continues to order and summarize the data based on the configuration. At 208, the process 200 continues to transmit and display the data in a summary format on the user device 180.

In one embodiment, the process 200 continues at 210 to select a visualization graphic 190 that represents a data metric 104 to apply to the data displayed on the device 180 in the summary format. The device 180 overlays 212 the visualization graphic on the displayed data to reveal an interpretation of the data based on the data metric. Next, the user device 180 determines 214 whether the user of the device is interacting with the visualization graphic and/or data displayed in the summary format. If yes, the user device triggers 216 an adjustment/override of the data metric represented by the visualization graphic. For example, the user device 180 may initiate actions to adjust or override a forecast quota in response to user input.

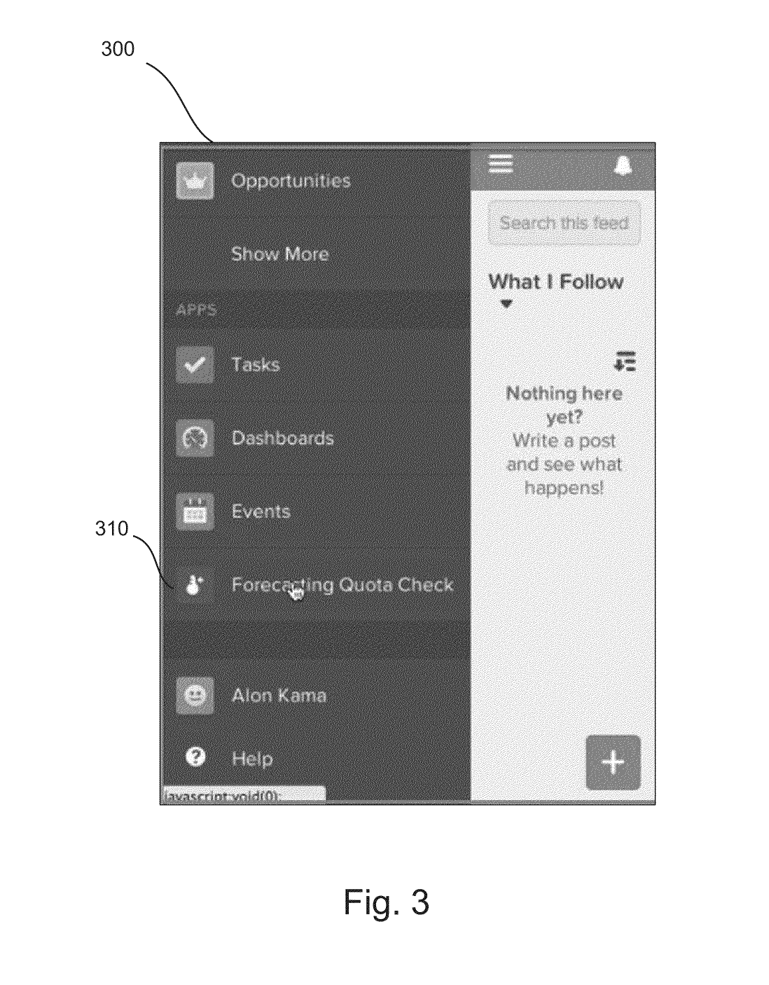

FIGS. 3-6 illustrate a series of exemplary GUIs for visualizing forecast data on a device according to one embodiment. It should be understood that, although the screenshots are illustrative of a GUI that is typically implemented as an application running on a mobile computing device, other GUIs suitable for use in other types of user computing devices, including browser web applications running on those devices, are also contemplated in other embodiments.

In FIG. 3, an initial application window 300 provides a user with a navigation point 310 for visualizing forecast data according to one embodiment. In the illustrated example, using the sales management scenario, the navigation point of entry 310 is labeled “Forecasting Quota Check.”

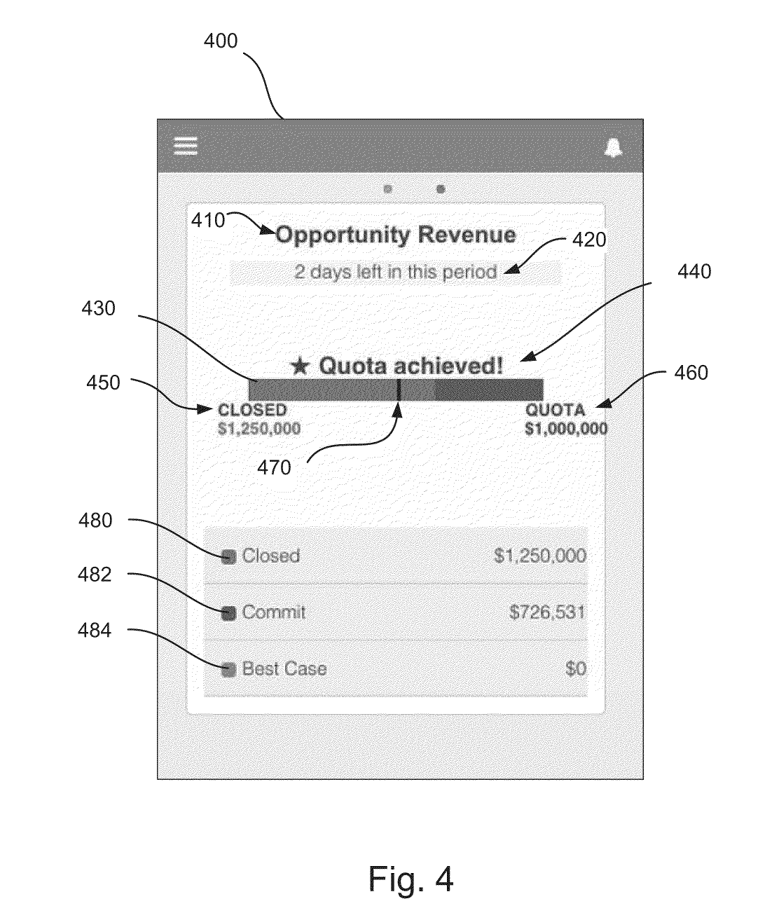

In FIG. 4, a window 400 for displaying the category of sales opportunity revenue 410 data in a summary format is illustrated, labeled 420 with the information “2 days left in this period.” A graphical overlay in the form of a quota attainment bar 430 is overlayed horizontally on a portion of the window 400, where the bar is sized to represent the forecasted amount of revenue for the user. The bar 430 is subdivided at a point 470 that represents the forecasted quota for the opportunity revenue 410 data category, with the portion of the bar on the left marked (in color or some other differentiator) to represent the closed opportunities 450 labeled “CLOSED” along with the total closed revenue, in this case “$1,250,000.” The portion of the bar on the right is marked to represent the remaining quota 460 of opportunities for the opportunity revenue category 410 that is not yet closed, and is labeled as “QUOTA” with the total remaining forecasted revenue “$1,000,000.” Additional text or graphics 440, such as the illustrated “★Quota Achieved!” may be displayed as an additional indicator of whether the forecasted quota has been met. Beneath this summary display are links 480, 482 and 484 to more detailed data for the closed, committed and best case revenue data categories.

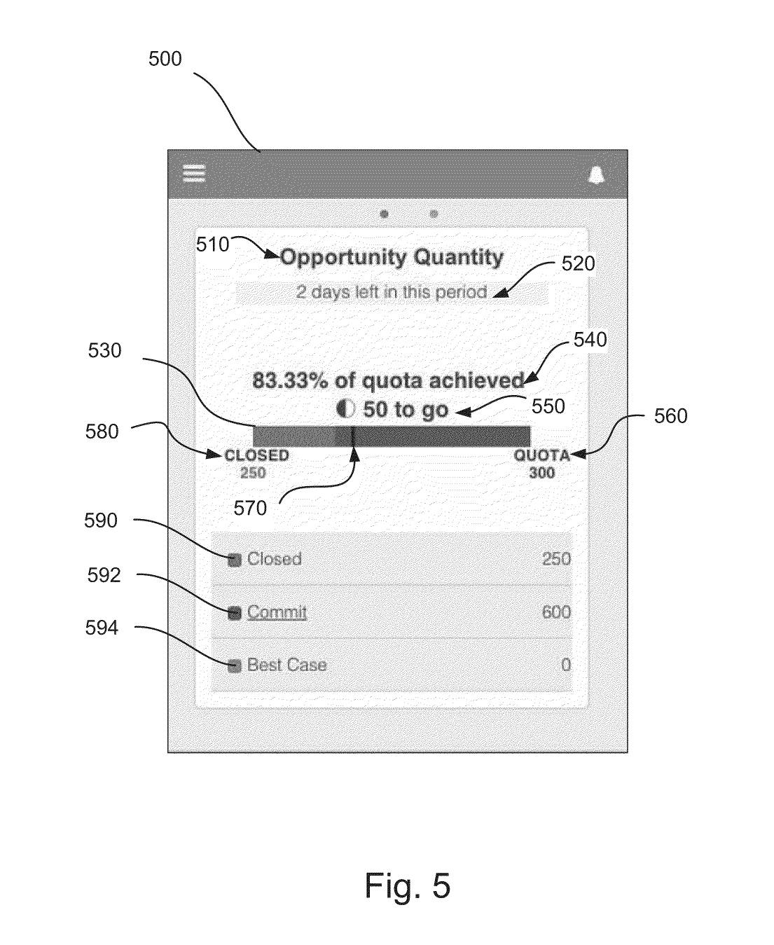

In FIG. 5, a window 500 for displaying the category of sales opportunity quantity 510 data in a summary format is illustrated, labeled 520 with the information “2 days left in this period.” As with the revenue example window 400, a graphical overlay in the form of a quota attainment bar 530 is overlayed horizontally on a portion of the window 500, where the bar is sized to represent the forecasted quantity of sales opportunities for the user. The bar 530 is subdivided at a point 570 that represents the forecasted quota for the quantity of sales opportunities 510 data category, with the portion of the bar on the left marked (in color or some other differentiator) to represent the closed opportunities 580 labeled “CLOSED” along with the total closed quantity of sales opportunities, in this case “250.” The portion of the bar on the right is marked to represent the remaining quota 560 of sales opportunity quantity category 510 that is not yet closed, and is labeled as “QUOTA” with the total remaining forecasted quantity of sales opportunities “300.” Additional text or graphics 540 and 550, such as the illustrated “83.33% of ★quota achieved” and “ [symbol] 50 TO GO” may be displayed as an additional indicator of whether the forecasted quota has been met and/or an additional indicator of the amount of remaining quota 560 in terms of percentage or absolute quantity/amounts remaining. Beneath this summary display are links 590, 592 and 594 to more detailed data for the closed, committed and best case revenue data categories.

In each of the examples in FIGS. 4-5, the quota attainment bar 430/530 is associated with a data metric such as a quota for a particular category of data. As such, the quota attainment bar 430/530 is one example of using a graphical overlay to visualize forecast data so that a user can, at a glance, determine whether they are meeting or exceeding their individual quota according to an embodiment. In one embodiment, the bar 430/530 is interactive in that a user may interact with the graphical overlay to adjust or override a quota for a particular category such as by moving the point 470/570 where the bar is subdivided to reflect the adjusted or overridden quota. Alternative, a separate interactive control may be provided for a user to enter a particular input, such as an amount or quantity, that will adjust or override the quota. In that case the bar 430/530 would be redisplayed with the point 470/570 relocated along the bar 430/530 to reflect the adjusted or overridden quota.

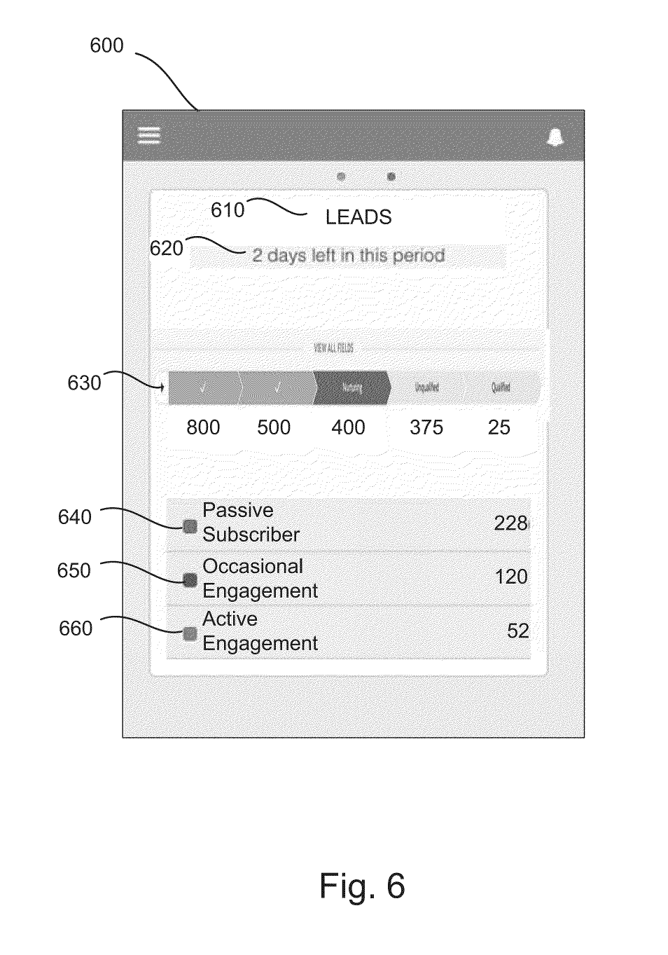

In FIG. 6, a window 600 for displaying the category of sales leads 610 data in a summary format is illustrated, labeled 620 with the information “LEADS” and the indication “2 days left in this period,” to represent the number of days left in the current sales cycle. As with the opportunity revenue and quantity example windows 400/500, a graphical overlay in the form of a bar 630 is overlayed horizontally on a portion of the window 600. In this scenario, the bar represents a linear path to closing sales opportunities in the context of sales leads, where a sales lead is defined as a prospective customer. In one embodiment, the bar is sized to represent the forecasted number of sales leads for the user in a given sales cycle period. Rather than a single quota attainment, the bar 630 is used to represent a breakdown of the forecasted quota of sales leads for the user as the sales leads pass through a life cycle of stages, from new contact to a qualified contact.

In one embodiment, the bar 630 is subdivided into multiple categories representing the stages through which the sales lead passes. For example, in the illustrated embodiment the multiple categories, depicted from left to right are New, Contacted, Nurturing, Unqualified and Qualified. In the example, there are 800 sales leads forecasted for the New category, 500 in the Contacted category, 400 in the Nurturing category, 375 in the Unqualified category and, finally, 25 in the Qualified category. In order to meet the forecasted quota of 25 sales leads in the Qualified category, a sales associate would be tasked with contacting and nurturing the forecasted number of sales leads until they reach the Unqualified and Qualified categories.

Thus, for example, a sales associate may be tasked with quotas for contacting 500 of the 800 new sales leads, and nurturing 400 sales leads before bringing the forecasted number of 375 sales leads into the Unqualified category and, ultimately, 25 sales leads into the Qualified category. The sales associate can visually track their progress toward meeting their quotas using window 600. In one embodiment, the sales associate interacts with the bar 630 by selecting the category of interest to obtain more detail about the status of her/his performance in meeting quotas for generating sales leads during the current sales cycle. For example, in order to track the number of sales leads the sales associate is currently nurturing, s/he can select the Nurturing category to reveal a detailed breakdown of the number of sales leads currently in “active engagement” 660 versus the number in “occasional engagement” 650 or that are considered “passive subscribers” 640.

In one embodiment, as the forecasted quota, or number of sales leads, is attained for each category of sales lead stages, the subdivided portions of the bar 630 may be updated with a quota met indicator such as a check mark. In the illustrated example, the sales leads quotas for the first two categories, New and Contacted, have been met. Those categories in which the forecasted quotas are still unmet may remain displayed with the forecasted number of sales leads, and are further selectable to reveal a detailed breakdown of the forecasted number of sales leads by any one or more subcategories of sales leads that the salesperson wishes to track, such as the aforementioned “active engagement,” “occasional engagement,” and “passive subscriber” subcategories.

In one embodiment, the detailed breakdown that is revealed upon selection of a sales lead category on the bar 630 can include interactive links 640, 650 and 660 to even more detailed data for each of the sales leads themselves, such as contact history, sales history, etc.

It is contemplated that other types of graphical overlays related to other data metrics other than quotas may be employed, including data metrics that can be applied, for example, not just to an individual user's data, but also to an aggregation of data over several users and/or over several different time periods of data accumulation.

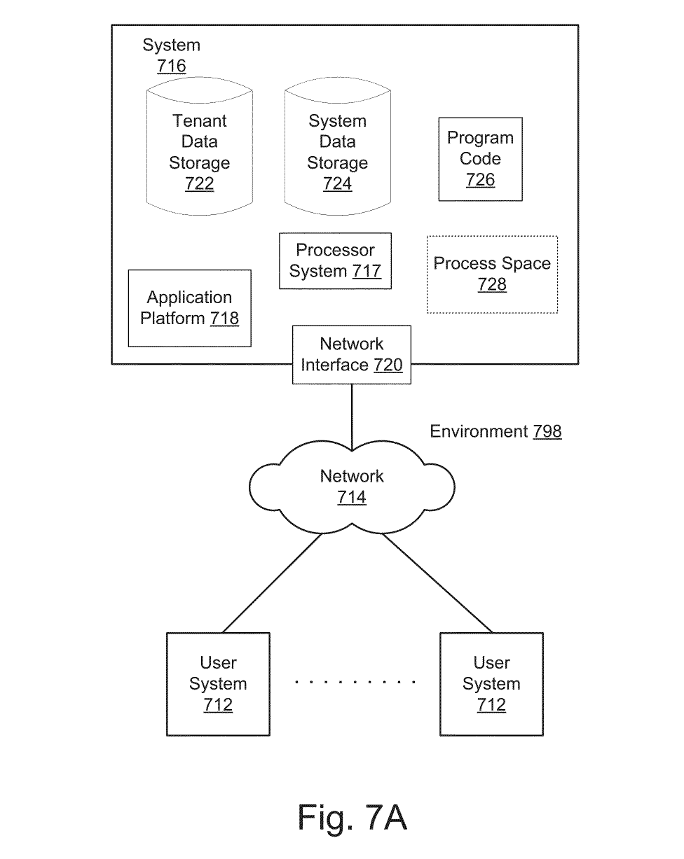

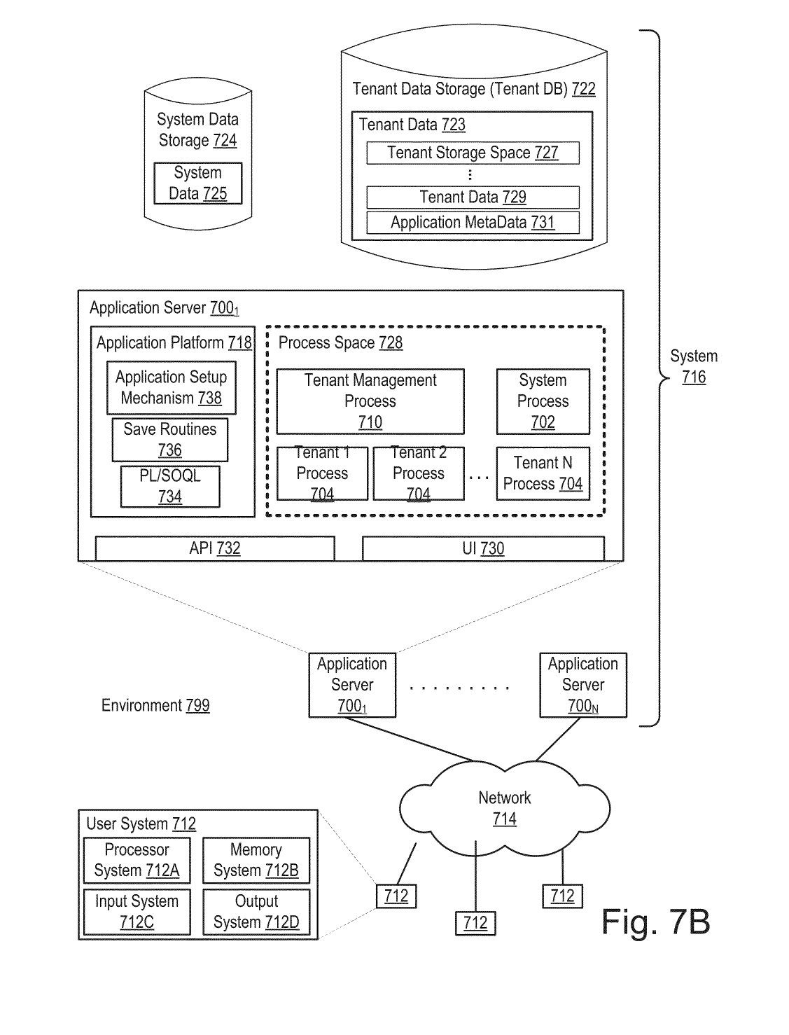

FIG. 7A illustrates a block diagram of an environment 798 in which an on-demand database service that supports visualizing forecast data in accordance with the described embodiments. Environment 798 may include user systems 712, network 714, system 716, processor system 717, application platform 718, network interface 720, tenant data storage 722, system data storage 724, program code 726, and process space 728. In other embodiments, environment 798 may not have all of the components listed and/or may have other elements instead of, or in addition to, those listed above.

Environment 798 is an environment in which an on-demand database service exists. User system 712 may be any machine or system that is used by a user to access a database user system. For example, any of user systems 712 can be a handheld computing device, a mobile phone, a laptop computer, a work station, and/or a network of computing devices. As illustrated in FIG. 7A (and in more detail in FIG. 7B) user systems 712 might interact via a network 714 with an on-demand database service, which is system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” is used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it is understood that the networks that the claimed embodiments may utilize are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7A, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7A, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7A include conventional, well-known elements that are explained only briefly here. For example, each user system 712 may include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Microsoft's Internet Explorer browser, a Mozilla or Firefox browser, an Opera, or a WAP-enabled browser in the case of a smartphone, tablet, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it is understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Pentium® processor or the like. Similarly, system 716 (and additional instances of an MTS, where more than one is present) and all of their components might be operator configurable using application(s) including computer code to run using a central processing unit such as processor system 717, which may include an Intel Pentium® processor or the like, and/or multiple processor units.

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS may include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It is understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7B illustrates another block diagram of an embodiment of elements of FIG. 7A and various possible interconnections between such elements in accordance with the described embodiments. FIG. 7B also illustrates environment 799. However, in FIG. 7B, the elements of system 716 and various interconnections in an embodiment are illustrated in further detail. More particularly, FIG. 7B shows that user system 712 may include a processor system 712A, memory system 712B, input system 712C, and output system 712D. FIG. 7B shows network 714 and system 716. FIG. 7B also shows that system 716 may include tenant data storage 722, having therein tenant data 723, which includes, for example, tenant storage space 727, tenant data 729, and application metadata 731. System data storage 724 is depicted as having therein system data 725. Further depicted within the expanded detail of application servers 700_{1-N} are User Interface (UI) 730, Application Program Interface (API) 732, application platform 718 includes PL/SOQL 734, save routines 736, application setup mechanism 738, process space 728 includes system process space 702, tenant 1-N process spaces 704, and tenant management process space 710. In other embodiments, environment 799 may not have the same elements as those listed above and/or may have other elements instead of, or in addition to, those listed above.

User system 712, network 714, system 716, tenant data storage 722, and system data storage 724 were discussed above in FIG. 7A. As shown by FIG. 7B, system 716 may include a network interface 720 (of FIG. 7A) implemented as a set of HTTP application servers 700, an application platform 718, tenant data storage 722, and system data storage 724. Also shown is system process space 702, including individual tenant process spaces 704 and a tenant management process space 710. Each application server 700 may be configured to tenant data storage 722 and the tenant data 723 therein, and system data storage 724 and the system data 725 therein to serve requests of user systems 712. The tenant data 723 might be divided into individual tenant storage areas (e.g., tenant storage space 727), which can be either a physical arrangement and/or a logical arrangement of data. Within each tenant storage space 727, tenant data 729, and application metadata 731 might be similarly allocated for each user. For example, a copy of a user's most recently used (MRU) items might be stored to tenant data 729. Similarly, a copy of MRU items for an entire organization that is a tenant might be stored to tenant storage space 727. A UI 730 provides a user interface and an API 732 provides an application programmer interface into system 716 resident processes to users and/or developers at user systems 712. The tenant data and the system data may be stored in various databases, such as one or more Oracle™ databases.

Application platform 718 includes an application setup mechanism 738 that supports application developers' creation and management of applications, which may be saved as metadata into tenant data storage 722 by save routines 736 for execution by subscribers as one or more tenant process spaces 704 managed by tenant management process space 710 for example. Invocations to such applications may be coded using PL/SOQL 734 that provides a programming language style interface extension to API 732. Invocations to applications may be detected by one or more system processes, which manages retrieving application metadata 731 for the subscriber making the invocation and executing the metadata as an application in a virtual machine.

Each application server 700 may be communicably coupled to database systems, e.g., having access to system data 725 and tenant data 723, via a different network connection. For example, one application server 700₁ might be coupled via the network 714 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 712 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user may hit three different application servers 700, and three requests from different users may hit the same application server 700. In this manner, system 716 is multi-tenant, in which system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 700 to request and update system-level and tenant-level data from system 716 that may require sending one or more queries to tenant data storage 722 and/or system data storage 724. System 716 (e.g., an application server 700 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method for visualizing forecast data, the method comprising:
retrieving a configuration, the configuration identifying one or more categories of data and a forecast related to the one or more categories;
collecting reported data;
ordering the collected data by category;
displaying the ordered data by category in a summary format; and
overlaying the displayed data with a graphical overlay representing the forecast, the graphical overlay revealing at a glance whether the reported data meets or exceeds the forecast.

2. The method of claim 1, wherein:
the identified category is sales opportunities;
the reported data is any one of sales opportunity revenue and sales opportunity quantity; and
the forecast is a quota of any one of sales opportunity revenue and sales opportunity quantity.

3. The method of claim 1, wherein the graphical overlay is subdivided at a first point representing the forecasted quota and at a second point representing the reported data, the method further comprising receiving a user input to adjust the forecasted quota represented by the graphical overlay.

4. The method of claim 3, wherein the user input to adjust the forecasted quota represented by the graphical overlay is to move a location of the first point subdividing the graphical overlay to a location on the graphical overlay that represents the adjusted quota.

5. The method of claim 3, wherein the user input to adjust the forecasted quota represented by the graphical overlay is to:
enter one of a revenue and a quantity, the entered one of the revenue and the quantity to adjust the forecasted quota represented at the first point subdividing the graphical overlay; and
change a display of the location on the graphical overlay to a location that represents the adjusted quota.

6. The method of claim 1, wherein:
the one or more identified categories correspond to a plurality of stages of a life cycle through which a sales lead progresses from a prospective customer to a customer;
the reported data is sales leads at each stage of the life cycle; and
the forecast is a quota of sales leads at each stage of the life cycle.

7. The method of claim 6, further comprising:
collapsing the reported data into multiple categories representing the stages of the life cycle;
displaying the multiple categories of data in a summary format; and
overlaying the displayed summary format of the data with a graphical overlay subdivided to represent the forecasted quota of sales leads at each stage of the life cycle, the graphical overlay revealing at a glance the progress toward meeting or exceeding the forecasted quota of sales leads at each stage of the life cycle.

8. The method of claim 7, further comprising:
receiving a user input to interact with the subdivided graphical overlay to select one of the plurality of stages of the life cycle; and
displaying one or more sub-categories of reported data for the selected stage, the subdivided graphical overlay revealing at a glance how the collapsed reported data of the selected stage breaks down into sub-categories of reported data, the sub-categories of reported data displayed in a detailed format.

9. The method of claim 7, further comprising:
receiving a user input to adjust the forecasted quota of sales leads for one of the stages of the life cycle represented by the subdivided graphical overlay.

10. A system for visualizing forecast data, the system comprising:
a configuration stored in a memory, the configuration identifying one or more categories of data and a forecast related to the one or more categories;
a data source from which reported data is collected;
a display interface on which to view the reported data;
a processor for generating summaries and visualizations of the reported data for display on the display interface in accordance with the configuration, wherein generating the summaries and visualizations include:
collecting reported data;
ordering the collected data by category;
displaying on the display interface the ordered data by category in a summary format; and
overlaying the displayed data with a graphical overlay representing the forecast, the graphical overlay revealing at a glance whether the reported data meets or exceeds the forecast.

11. The system of claim 1, wherein:
the identified category is sales opportunities;
the reported data is any one of sales opportunity revenue and sales opportunity quantity; and
the forecast is a quota of any one of sales opportunity revenue and sales opportunity quantity.

12. The system of claim 1, wherein the graphical overlay is subdivided at a first point representing the forecasted quota and at a second point representing the reported data, the method further comprising receiving a user input to adjust the forecasted quota represented by the graphical overlay.

13. The system of claim 12, wherein the user input to adjust the forecasted quota represented by the graphical overlay is to move a location of the first point subdividing the graphical overlay to a location on the graphical overlay that represents the adjusted quota.

14. The system of claim 12, wherein the user input to adjust the forecasted quota represented by the graphical overlay is to:
enter one of a revenue and a quantity, the entered one of the revenue and the quantity to adjust the forecasted quota represented at the first point subdividing the graphical overlay; and
change a display of the location on the graphical overlay to a location that represents the adjusted quota.

15. The system of claim 10, wherein:
the one or more identified categories correspond to a plurality of stages of a life cycle through which a sales lead progresses from a prospective customer to a customer;
the reported data is sales leads at each stage of the life cycle; and
the forecast is a quota of sales leads at each stage of the life cycle.

16. The system of claim 15, further comprising:
collapsing the reported data into multiple categories representing the stages of the life cycle;
displaying the multiple categories of data in a summary format; and
overlaying the displayed summary format of the data with a graphical overlay subdivided to represent the forecasted quota of sales leads at each stage of the life cycle, the graphical overlay revealing at a glance the progress toward meeting or exceeding the forecasted quota of sales leads at each stage of the life cycle.

17. The system of claim 16, further comprising:
receiving a user input to interact with the subdivided graphical overlay to select one of the plurality of stages of the life cycle; and
displaying one or more sub-categories of reported data for the selected stage, the subdivided graphical overlay revealing at a glance how the collapsed reported data of the selected stage breaks down into sub-categories of reported data, the sub-categories of reported data displayed in a detailed format.

18. The system of claim 16, further comprising:
receiving a user input to adjust the forecasted quota of sales leads for one of the stages of the life cycle represented by the subdivided graphical overlay.

19. An article of manufacture comprising a computer readable storage medium having content stored thereon, which when executed, cause a machine to perform operations including:
retrieving a configuration, the configuration identifying one or more categories of data and a forecast related to the one or more categories;
collecting reported data;
ordering the collected data by category;
displaying the ordered data by category in a summary format; and
overlaying the displayed data with a graphical overlay representing the forecast, the graphical overlay revealing at a glance whether the reported data meets or exceeds the forecast.

20. The article of manufacture of claim 19, wherein:
the identified category is sales opportunities;
the reported data is any one of sales opportunity revenue and sales opportunity quantity; and
the forecast is a quota of any one of sales opportunity revenue and sales opportunity quantity.

21. The article of manufacture of claim 19, wherein the graphical overlay is subdivided at a first point representing the forecasted quota and at a second point representing the reported data, the method further comprising receiving a user input to adjust the forecasted quota represented by the graphical overlay.

22. The article of manufacture of claim 21, wherein the user input to adjust the forecasted quota represented by the graphical overlay is to move a location of the first point subdividing the graphical overlay to a location on the graphical overlay that represents the adjusted quota.

23. The article of manufacture of claim 21, wherein the user input to adjust the forecasted quota represented by the graphical overlay is to:
enter one of a revenue and a quantity, the entered one of the revenue and the quantity to adjust the forecasted quota represented at the first point subdividing the graphical overlay; and
change a display of the location on the graphical overlay to a location that represents the adjusted quota.

24. The article of manufacture of claim 19, wherein:
the one or more identified categories correspond to a plurality of stages of a life cycle through which a sales lead progresses from a prospective customer to a customer;
the reported data is sales leads at each stage of the life cycle; and
the forecast is a quota of sales leads at each stage of the life cycle.

25. The article of manufacture of claim 24, the operations further including:
collapsing the reported data into multiple categories representing the stages of the life cycle;
displaying the multiple categories of data in a summary format; and
overlaying the displayed summary format of the data with a graphical overlay subdivided to represent the forecasted quota of sales leads at each stage of the life cycle, the graphical overlay revealing at a glance the progress toward meeting or exceeding the forecasted quota of sales leads at each stage of the life cycle.

26. The article of manufacture of claim 25, further comprising:
receiving a user input to interact with the subdivided graphical overlay to select one of the plurality of stages of the life cycle; and
displaying one or more sub-categories of reported data for the selected stage, the subdivided graphical overlay revealing at a glance how the collapsed reported data of the selected stage breaks down into sub-categories of reported data, the sub-categories of reported data displayed in a detailed format.

27. The article of manufacture of claim 25, further comprising:
receiving a user input to adjust the forecasted quota of sales leads for one of the stages of the life cycle represented by the subdivided graphical overlay.
